(19) United States
(12) Patent Application Publication
(10) Pub. No.: US 2023/0408696 A1
(43) Pub. Date: Dec. 21, 2023

(54) SYSTEMS AND METHODS FOR TRACKING THREE-DIMENSIONAL OBJECTS

(71) Applicant: Acushnet Company, Fairhaven, MA (US)

(72) Inventors: Jeremy Zorrilla Del Los Santos, Whitinsville, MA (US); Nicholas M. Nardacci, Barrington, RI (US); Paul Furze, Tiverton, RI (US); Brett Southworth, New Bedford, MA (US)

(21) Appl. No.: 17/840,146

(22) Filed: Jun. 14, 2022

(51) Int. Cl. G01S 17/66; G01S 17/86; G01S 17/58

(52) U.S. Cl. CPC G01S 17/66; G01S 17/58; G01S 17/86

(57) ABSTRACT

A system for determining kinematics of at least one object including a tracking computer including one or more processors and a memory, a camera system in electronic communication with the tracking computer and configured to capture images of the at least one object, and a LIDAR system in electronic communication with the tracking computer and configured to detect the at least one object. The memory contains processor-executable instructions that, when executed by the one or more processors, cause the tracking computer to receive image data from the camera system and receive LIDAR data from the LIDAR system, and analyze the image data and the LIDAR data to determine flight characteristics of the at least one object.

### TECHNICAL FIELD

The present disclosure relates generally to the field of object tracking, and more specifically to tracking objects using light detection and ranging (LIDAR).

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Tracking objects moving in three dimensions may have various practical applications. For example, it may be useful to track the flight of balls or objects used in sports such as golf balls, baseballs, footballs, etc., to, among other things, simulate flight paths, predict initial launch conditions, etc. Traditional systems for tracking objects may encounter several limitations, such as motion blur at high speeds, problems reconciling variable lighting conditions, problems based on object and/or material color, and the size and/or shape of the object.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes a system for determining kinematics of at least one object. The system may include a tracking computer including one or more processors and a memory, a camera system in electronic communication with the tracking computer and configured to capture images of the at least one object, and a light detection and ranging (LIDAR) system in electronic communication with the tracking computer and configured to detect the at least one object. The memory may contain processor-executable instructions that, when executed by the one or more processors, may cause the tracking computer to receive image data from the camera system and receive LIDAR data from the LIDAR system, and analyze the image data and the LIDAR data to determine flight characteristics of the at least one object.

In another embodiment, the disclosure describes a system for determining kinematics of at least one object. The system may include a tracking computer including one or more processors and a memory and a light detection and ranging (LIDAR) system in electronic communication with the tracking computer and configured to detect the at least one object. The memory may contain processor-executable instructions that, when executed by the one or more processors, cause the tracking computer to receive LIDAR data from the LIDAR system, and analyze the LIDAR data to determine flight characteristics of the at least one object.

In another embodiment, the disclosure describes a method of tracking a three-dimensional (3D) object. The method may include scanning for the 3D object using one or more LIDAR devices in one or more fields of view and detecting the 3D object using the one or more LIDAR devices. The method may include generating LIDAR data with the one or more LIDAR devices based on the detecting of the 3D object and transmitting the LIDAR data from the one or more LIDAR devices to a tracking computer. The method may include analyzing the LIDAR data to determine flight characteristics of the 3D object based on the LIDAR data.

### BRIEF DESCRIPTION OF THE DRAWINGS

Non-limiting and non-exhaustive embodiments are described in reference to the following drawings. The components in the figures are not necessarily to scale, emphasis instead being placed upon illustrating the principles of the disclosure. In the drawings, like reference numerals refer to like parts through all the various figures unless otherwise specified.

For a better understanding of the present disclosure, a reference will be made to the following detailed description, which is to be read in association with the accompanying drawings, wherein:

FIG. 1 is a schematic depiction of an embodiment of a system for tracking 3D objects in accordance with the disclosure;

FIG. 2A is a schematic representation of an embodiment of first scan area in a first field of view from the perspective of a LIDAR device in accordance with the disclosure;

FIG. 2B is a schematic representation of an embodiment of a second scan area in the first field of view from the perspective of the LIDAR device of FIG. 2A;

FIG. 2C is a schematic representation of an embodiment of a third scan area in the first field of view from the perspective of the LIDAR device of FIG. 2A;

FIG. 3 is a flow chart of an embodiment of a method for tracking a 3D object in accordance with the disclosure;

FIG. 4 is a flow chart of an embodiment of a dynamic field of view method in accordance with the disclosure;

FIG. 5 is a schematic illustration of elements of an embodiment of an example computing device; and

FIG. 6 is a schematic illustration of elements of an embodiment of a server type computing device.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. This disclosure may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and includes plural references. The meaning of “in” includes “in” and “on.”

In some embodiments, the disclosure describes systems and methods for providing improved tracking and analyzing of three-dimensional (3D) objects, such as golf balls in flight. In some embodiments, the disclosed tracking system may implement light detection and ranging (LIDAR) techniques and technology to determine kinematics and other characteristics of an object in flight, including but not limited to speed, spin, trajectory, launch angle, etc. In some embodiments, the tracking systems described herein may include the use of LIDAR technology alone, or may include a combination of LIDAR technology and vision technology (e.g., high speed cameras, etc.), to track and analyze flight characteristics of 3D objects. In some embodiments, the use of LIDAR technology may improve upon or overcome many of the shortcomings in traditional object tracking, including motion blur particularly at high speed, problems with variable lighting conditions, and problems with material color, size, and/or shape. In some embodiments, the tracking system and methods may be used in one or more practical applications, such as aiding in golf ball or golf club research and the development of new golf balls or golf clubs.

In some embodiments, the tracking system and methods may use LIDAR technology to scan a field of view through which a golf ball or other object may travel. In some embodiments, multiple LIDAR devices may be used that may each scan a field of view on multiple distinct axes, such as two or three axes that may be orthogonal to one another (e.g., x, y, and/or z axes). In some embodiments, a single LIDAR device may be used, or multiple LIDAR devices oriented to capture fields of view that may not be orthogonal to one another, so long as the angle to one another may be known and accounted for. In some embodiments, when the object (e.g., golf ball, baseball) moves through the field of view (FOV), the one or more LIDAR devices may measure the object's position over time. The position-time measurements may then be used to determine characteristics about the object's flight path, such as launch conditions (e.g., speed, angle, acceleration, etc.), direction of a club or bat striking the object (e.g., club face angle), etc. In some embodiments, vision technology (e.g., high speed cameras), may be paired with the LIDAR technology and may provide additional information regarding the object's flight characteristics. For example, a high speed camera may visually track the rotation of the object as it may move across the camera's field of view. In such embodiments, the tracking system may provide relatively high precision information regarding the object's flight path, spin, launch conditions, etc.

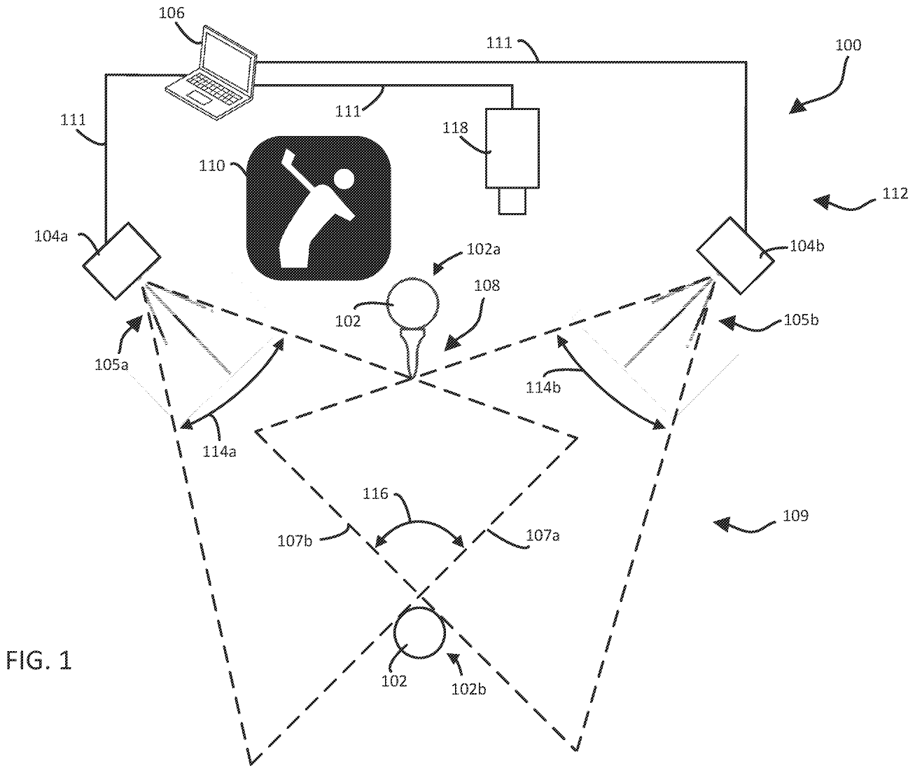

FIG. 1 shows an embodiment of a 3D object tracking system 100. In some embodiments, the system 100 may include one or more LIDAR devices 104, one or more camera devices 118, an object 102 for tracking, and a tracking computer 106. Each of the one or more LIDAR devices 104 and the one or more cameras 118 may be in electronic communication with the tracking computer 106 via one or more cables 111, or may communicate with the tracking computer 106 or one another wirelessly, such as via any suitable wireless communication protocol (e.g., Bluetooth, Wifi, near field communication (NFC), etc.). In some embodiments, the tracking computer 106 may be more than one computer, and/or may be part of the one or more LIDAR devices and/or one or more cameras 118. Additionally or alternatively, the tracking computer 106 may be remote from the rest of the system 100, such as a remote server system or a remote cloud computing system connected via a local area network (LAN), a wide area network (WAN), the Internet, or other suitable electronic communication. The tracking computer 106 may be specially configured to analyze tracking data provided by the LIDAR devices 104 and/or the cameras 118, and may run specialized tracking software that may receive, store, analyze, and/or generate flight characteristics of the object 102. In some embodiments, the tracking software may include a graphical user interface (GUI) that may display graphics or other information pertaining to the tracking system 100, and may be configured to receive inputs from a user or other sources relating to parameters or other information analysis.

In some embodiments, the LIDAR devices 104 and the cameras 118 may be disposed up range 112 from a launch point 108 of the object 102, and the LIDAR devices and camera may be configured to track the object's flight characteristics down range 109 of the launch point 108. The object 102 may have a launch position 102a at the launch point 108, and may have multiple flight positions 102b down range of the launch point. In some embodiments, a user 110 may launch the object 102 down range 109 from the launch point 108, such as by striking the object with a golf club, baseball bat, or other implement. In some embodiments, the system 100 may include a triggering device at or near the launch point 108 that may be in electronic communication (wired or wirelessly) with the tracking computer 106, the camera 118, and/or the LIDAR devices 104. In some embodiments, the triggering device may be triggered when the object 102 is launched, either mechanically, optically, electronically, etc., and may transmit launch signals to the tracking computer 106, the camera 118, and/or the LIDAR device 104 indicating that an object 102 has been launched. In some embodiments, the object 102 may be a golf ball and the user 110 may strike the golf ball with a golf club.

### LIDAR System

The one or more LIDAR devices 104 may include a first LIDAR device 104a and a second LIDAR device 104b. LIDAR devices may generally be used to determine ranges to objects or surfaces using a laser or lasers that may include ultraviolet, visible, or near infrared light. The one or more LIDAR devices may be of any suitable type, such as incoherent or coherent, micropulse or high energy, spindle-type, solid-state, flash LIDAR. In some embodiments, the one or more LIDAR devices 104 may all be of the same design or may be of various designs. In some embodiments, the one or more LIDAR devices 104 may utilized a single scanning laser, or may utilized multiple scanning lasers. In some embodiments, the first LIDAR device 104a may emit pulses of one or more first lasers 105a and the second LIDAR device 104b may emit pulses of one or more second lasers 105b.

In some embodiments, lasers or other light may be emitted from each of the one or more LIDAR devices 104, some of which may strike the object 102 in flight down range 109. Portions of the lasers may be reflected back to the one or more LIDAR devices and detected by one or more detectors in each LIDAR device. The time between emission of a particular laser pulse and that pulse's arrival back at the detector may be used to determine the distance to a surface of the object 102 at a given point in time. Over time, as additional object surface locations may be located down range 109 during the object's 102 flight, the tracking computer 106 may receive and analyze each data point, and using mathematical techniques, extrapolate information about the object's flight path and trajectory or may determine instantaneous flight information.

In some embodiments, the LIDAR devices 104 may each repeatedly emit a single laser pulse that may be redirected across a one or two-dimensional field of view (FOV) at a predetermined frequency. Pulse repetition rates may vary by embodiment, but may range, for example, between several hundred pulses per second (e.g., 150-300 Hz) and hundreds of thousands of pulses per second (e.g., 150-300 KHz). In some embodiments, the LIDAR devices 104 may have a scan frequency of greater than 150 kHZ. In some embodiments, the LIDAR devices 104 may include lasers with a pulse wavelength between about 1,500 nanometers and about 2,000 nanometers. In some embodiments, the higher the pulse repetition rate and number of times the FOV may be scanned during the object's flight, the more accurate the tracking system 100 may be at determining flight characteristics such as launch conditions. Those skilled in the art will recognize that LIDAR, laser, and sensor technology may continue improving over time and such improvements may be reflected in the scope of the disclosure. In some embodiments, the single repeating laser pulses from each LIDAR device 104 may scan a given FOV one or more times during the object's 102 flight. In some embodiments, the LIDAR devices 104 may use multi scan lasers, where each device may emit multiple laser pulses at a time, allowing for increased scanning rates and/or higher resolution imaging than may be possible with single laser devices. When multiple laser pulses may be emitted at once, a larger portion of the FOV may be covered per unit of time and, accordingly, more information about the object's 102 positioning in the FOV per unit of time may be available for analysis by the tracking computer 106. Those skilled in the art will also appreciate that other LIDAR technologies may be implemented within the scope of the disclosure.

The LIDAR devices 104 may each be oriented to scan a particular field of view 107 down range 109 of an object 102 launch point 108. In some embodiments, the first LIDAR device 104a may be positioned and configured to scan a first field of view (FOV) 107a, and the second LIDAR device 104b may be positioned and configured to scan a second FOV 107b. In some embodiments, the first FOV 107a and the second FOV 107b may be substantially orthogonal to one another, such that FOV angle 116 may be about 90 degrees. In some embodiments, additional LIDAR devices 104 may also be used that may be positioned and configured to scan additional FOVs that may or may not be orthogonal to one or both of the first FOV 107a and the second FOV 107b. In some embodiments, each LIDAR device 104 may be configured to scan a portion of the FOV defined by a horizontal and/or vertical angle. The size or area of the first FOV 107a may be determined based on a first horizontal scan angle 114a and a first vertical scan angle, and the second FOV 107b may be determined based on a second horizontal scan angle 114b and a second vertical scan angle. In one, non-limiting example, the first and second horizontal scan angle 114a, 114b may be about 20 degrees, and the first and second vertical scan angle may be about 40 degrees, although those skilled in the art will recognize that other angles may be used. Relatively smaller FOVs may be scanned faster than larger FOVs and therefore may allow for higher resolution imaging and greater accuracy, all else equal. However, if a FOV is too small, the object 102 may not appear in the FOV at all, or may only appear for a short amount of time. A relatively larger FOV may provide for greater likelihood of object detection, but may limit resolution due to longer scan times and relatively fewer data points, all else equal.

In some embodiments, image resolution may be increased without decreasing the size of the FOV by using additional LIDAR devices 104. Multiple LIDAR devices may work in tandem to scan down range 109 more quickly, or provide for additional scanning density in the same amount of time as a single LIDAR device would take to cover the same area. For example, using two LIDAR devices 104 instead of one LIDAR device may allow the system 100 effectively double number of data points acquired during a given time period, or may expand the down range area covered during that time period. Of course, those skilled in the art will recognized that virtually any number of LIDAR devices may be used to increase the resolution, increase the scanned area, reduce scan time, or all three.

In some embodiments, scan time may be reduced (and thus resolution increased) by using LIDAR devices with multi scan lasers, as discussed above. In some embodiments, the tracking system 100 may benefit from using relatively small FOVs, for example, about 20 degrees horizontally by about 40 degrees vertically. In some embodiments, the scanned field down range 109 may become dense with laser pulses such that laser pulses from the first LIDAR device 104a and the second LIDAR device 104b (or additional LIDAR devices) may interfere with one another. In other words, there may be cross talk between the multiple laser/receiver pairs in the LIDAR devices 104. In some embodiments, this interference may be reduced by assigning a unique wavelength to each laser/receiver pair in each LIDAR device 104. In such embodiments, each respective receiver may be programmed or otherwise configured to only recognize or to only process lasers received at the unique wavelength assigned to that particular LIDAR device. For example, each LIDAR devices or the receivers themselves may include a narrow bandpass optical filter, matched to each respective laser, that may block light from the other lasers (i.e, other wavelengths). Alternatively (or in addition), tracking software may be programmed or configured to only recognize (i.e., only “count”) returns from lasers having the wavelength assigned to that particular LIDAR device. In some embodiments, another way to reduce and/or avoid interference may be to separate each laser/receiver pair by timing. In such embodiments, each LIDAR device 104 may be configured to emit laser pulses at times when the other LIDAR devices may not be emitting laser pulses. For example, the first LIDAR device 104a may emit a laser pulse or multi pulse 105a first, the second LIDAR device 104b may emit a laser pulse or multi pulse 105b second, and the pulses may then be offset so as to never overlap in time and thus reduce or avoid interference. In some embodiments, each LIDAR device 104 may be in electronic communication with one another to effectively stagger the laser pulses, or may be coordinated via the tracking computer 106 or another computing device. In some embodiments, the distance from the receiver to the object 102 may be relatively short, such as less than 10 feet. In such embodiments, the time for each laser pulse to reflect from the object 102 and return to the receiver may be relatively short, such as in the range of about 20 nanoseconds. In one non-limiting example, coordinating the LIDAR devices such that the laser pulse(s) from each LIDAR device 104 may be emitted once every 25 nanoseconds may allow the system 100 to take about 40,000,000 measurements per second.

In some embodiments, the disclosure describes implementing a dynamic FOV method that may reduce the size of the FOV that each LIDAR device may scan per unit time based on object flight characteristics determined on previous scans. For example, an FOV that may be 20 degrees by 40 degrees and containing a single object 102 (e.g., golf ball) that may be about two feet from the LIDAR devices may still be mostly empty space, as the object may subtend about 4 degrees of the FOV. Further, the scans that result in a signal reflected from the object provide the most information for analyzing the object's 102 flights characteristics. Accordingly, in some embodiments, the disclosure describes using the location of the object 102 to limit the FOV of each LIDAR device 104 to improve the useful scan rate, resolution, or both. In some such embodiments, each LIDAR device 104 may scan the entire FOV (e.g., 20 degrees by 40 degrees until an object may be detected (i.e., until returns from the laser pulses indicate an object in the FOV). Subsequent scans may then limit the FOV to an area within the original FOV where the object has been detected, and may in some embodiments include some margin for error (e.g., about 8 degrees by 8 degrees). In some embodiments, the FOV for subsequent scans may be decreased significantly (e.g., decreasing the field of view by 98%), thereby improving scan rates and/or improving resolution. In some embodiments, information regarding the speed and/or trajectory of the object may be used to predict subsequent FOV areas that may be most likely to include the object. Further, in some embodiments, the FOV may be additionally decreased as the distance to the object 102 down range 109 increases, as the object and any unpredictable object movements subtend a smaller angle. In embodiments where the system 100 uses multiple LIDAR devices 104, each laser may be redirected independently to efficiently scan the reduced field of view, further improving resolution and scan rate.

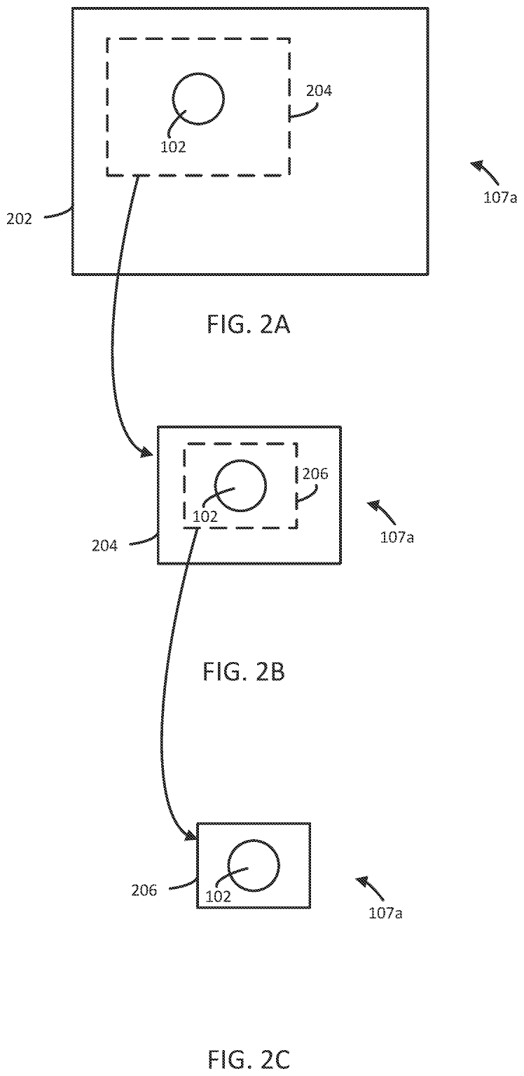

FIGS. 2A-C show an embodiment of the dynamic FOV method described above, from the perspective of the first LIDAR device 104a, though it should be understood that the same or similar methods could be used with the second LIDAR device 104b or any additional LIDAR devices. FIG. 2A shows an embodiment of a first scan area 202 of the first FOV 107a, for example, on a first LIDAR scan. If/when the first LIDAR device 104a detects the object 102 in the scan area 202 during the first scan, the first LIDAR device 104a may determine a second scan area 204 based on the location, speed, distance, and/or other flight characteristics of the object 102. In some embodiments, the second scan area 204 may include a smaller area than the first scan area 202. FIG. 2B shows an embodiment of the second scan area 204 of the first FOV 107a that may be scanned, for example, on a second LIDAR scan. Because the second scan area 204 may have a smaller area than the first scan area 202, the first LIDAR device 104a may achieve improved resolution and/or scan rate on the second LIDAR scan. If/when the first LIDAR device 104a detects the object 102 in the second scan area 204 during the second scan, the first LIDAR device 104a may determine a third scan area 206 based on the object flight characteristics determined during the second scan. FIG. 2C shows an embodiment of the third scan area 206 of the first FOV 107a that may be scanned, for example, on a third LIDAR scan. Because the third scan area 206 may have a smaller area than both the first scan area 202 and the second scan area 204, the first LIDAR device 104a may achieve more improved resolution and/or scan rate on the third LIDAR scan. Although FIGS. 2A-C show only three iterations of reducing the FOV area to increase resolution and improve scan rate, those skilled in the art will recognize that more or fewer iterations may be used in different embodiments.

In some embodiments, the LIDAR devices 104 themselves may be programed or physically configured to perform the dynamic FOV method described herein and with respect to FIGS. 2A-C. In some embodiments, the LIDAR devices 104 may include one or more internal processors physically configured to execute computer-readable instructions stored on a memory, either internal or external to the LIDAR devices 104. In some embodiments, the tracking computer 106 may additionally or alternatively receive and analyze the object flight data from each LIDAR scan from each LIDAR device 104, and provide each LIDAR device with instructions to change the scan area on one or more subsequent scans. Additionally, although the examples above refer to changing the area of the FOV after a first pass, those skilled in the art will recognize that the area of the FOV may be altered after virtually any number of scans as suitable to achieve improved scan rate and resolution.

In some embodiments, the one or more LIDAR devices 104 may achieve high enough resolution to map unique physical features of the surface of the object 102 in flight. In such embodiments, the LIDAR devices 104 may be able to determine additional object flight characteristics, such as spin. For example, the LIDAR devices 104 (or the tracking computer 106) may differentiate between the position of a particular physical surface feature at a first time (e.g., during a first scan) and the position of that same physical surface features at a second time (e.g., during a subsequent scan). The LIDAR device 104 and/or the tracking computer 106 may determine the spin of the object 102 based on, for example, the elapsed time between the first time and the second time, the distance that the physical surface feature has moved, a diameter of the object, the speed of the object, etc. In embodiments where the object 102 may be a golf ball, the golf ball surface may be substantially covered in dimples and/or concave craters surrounding the ball surface. In some embodiments, the LIDAR device 104 may differentiate between dimples on the golf ball such that object characteristics such as spin rate may be determinable. In other words, given enough granular definitions the LIDAR device 104 may capture substantially all the relevant object flight information within the field of view, even without the camera 118, as described below. In some embodiments, the system 100 may also or alternatively use Doppler LIDAR to sense the speed and/or acceleration of the object 102. Further, in some embodiments, spin of the object 102 may be inferred based on a speed difference between a top of the object and the bottom of the object. Of course, those skilled in the art will recognize that any of the above embodiments may also be used in combination with one another.

In some embodiments, substantially conventional LIDAR devices may be used or specially programmed to perform the tracking activities described herein. For example, LIDAR devices having a rotating mirror to direct the laser beam(s) for scanning an area may be used in some embodiments. In such embodiments, however, the scan rate of the FOV may be fixed to or otherwise related to the rotational speed of the mirror. In some embodiments, such as where a more flexible or dynamic scan rate may be desirable, the LIDAR devices 104 may include one or more mirrors that may move in alternative ways. For example, a voice coil may be connected to the mirror so as to enable the voice coil to rotate, bend, or otherwise alter the shape of the mirror and thus control reflected direction of the laser beams. In such embodiments, the laser beam may be directed to scan the FOV by altering a current flowing through the voice coil. In some embodiments, the current may be controlled by the tracking computer 106, or may be controlled by a separate controller internal to the LIDAR device, or by any other suitable control mechanism. In such embodiments, the FOV, range, and scan rate may be changed programmatically as desired for a given application, or to alter the FOV such as with reference to FIGS. 2A-C. In another embodiment, the mirror shape, position, and/or movement may be altered using a piezoelectric material that may move or change the mirror's shape in response to a programmable voltage change across the piezoelectric material. In some embodiments, other laser scanning technology may be used, such as micro motion technology.

### Camera System

In some embodiments, the system 100 may also include one or more visual trackers, such as cameras 118. The camera(s) 118 may be a high speed camera that may be capable of capturing images with relatively low exposure times, such as less than 1/1,000 second or may use frame rates in excess of 250 frames per second (fps). In some embodiments, it is contemplated that relatively lower speeds and fps may also be used. In some embodiments, the camera 118 may be capable of and/or configured to record and store images of the object 102 as it moves from the launch point 108 into a down range area 109. In some embodiments, the images captured by the camera 118 may be stored and played back, or be stored and used for analysis. In some embodiments, other types of cameras or visual trackers may be used within the scope of the disclosure. In some embodiments, the camera 118 may be configured to capture images in a sequential series of two or more images. In some embodiments, the camera 118 may be configured to capture images at a frame rate of greater than 200, 300, 400, or 500 frames per sec. In some embodiments, the camera 118 may be configured to capture images at a frame rate of greater than 600, 700, 800, 900, or 1000 frames per sec.

In some embodiments, the vision portion of the tracking system 100 may be used in combination with a marker detection algorithm to measure rotation of the object 102 as it moves across a field of view (FOV) of the camera system 118. In some embodiments, the camera 118 may be capable of acquiring multiple images within a set field of view. Each camera 118 may include a strobing lighting element that may be tied to a triggering device that may synchronize itself with the LIDAR devices 104. In some embodiments, the strobing lighting element may provide strobe lighting that may accentuate object movements or spin during flight that may be detectable with the camera system 118. In such embodiments, the camera 118 may be used to scan for predetermined patterns on the surface of the object. In some embodiments, the predetermined pattern may be made up of any rotationally unique marking that may be previously applied to the object. In some embodiments, if the markings are not unique geometric shapes, the markings may contain at least n+3 unique markings with an asymmetric layout.

### Object Tracking and Monitoring

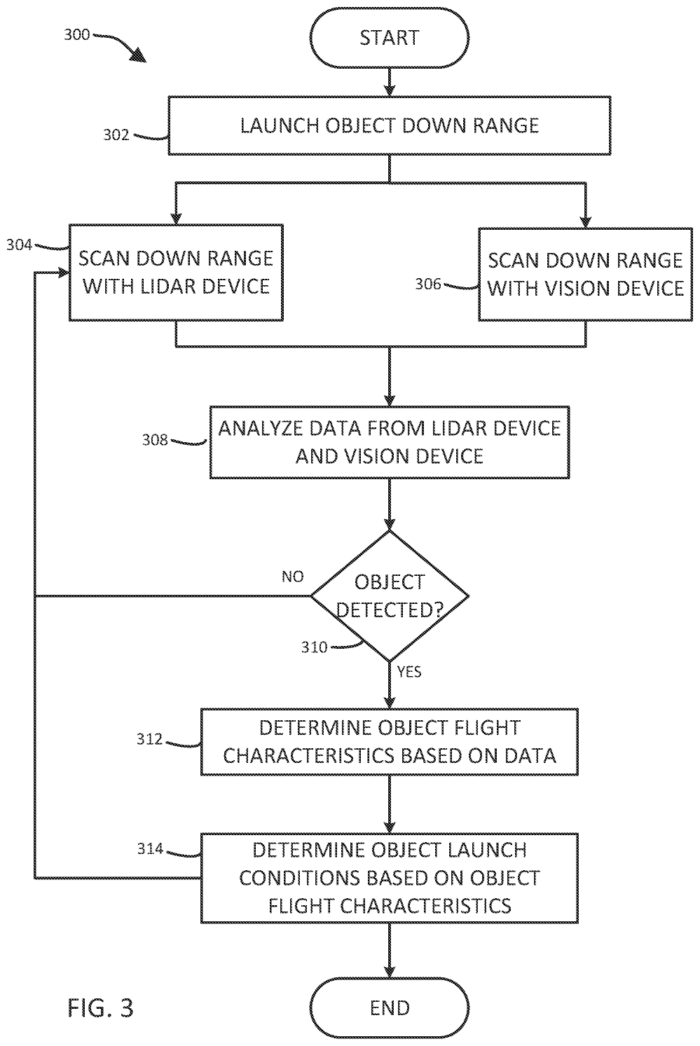

In some embodiments, the LIDAR devices 104 may be used alone to track and monitor object flight characteristics, or may be used in combination with the vision system including the one or more cameras 118. FIG. 3 is a flow chart of an embodiment 300 of tracking and monitoring an object, such as a golf ball, using a tracking system such as the 3D object tracking system 100. At 302, the object may be launched down range from a launch point. In some embodiments, the object may be launched via impact with a launch object, such as a golf club, baseball bat, racket, etc., either by a human user or mechanical device, such as a mechanical robot. At 304, one or more LIDAR devices, such as LIDAR devices 104, may scan down range and may detect the launched object. Object detection may occur using laser pulses or other suitable methods as described herein or as known in the art. At 306, a vision device, such as camera 118, may also scan down range to capture one or more images of the object. In some embodiments, the vision device may be tied to a trigger that may synchronize the vision device with the one or more LIDAR devices. In some embodiments, the vision device may not scan down range until the LIDAR device detects the object, at which point the LIDAR object and/or the tracking computer may signal the vision device to capture one or more images. At 308, the system may analyze data from the LIDAR device and/or the vision device to determine whether an object may have been detected down range. If, at 310, no object is detected, the system may continue scanning down range with the LIDAR device and/or the vision device, if, at 310, an object is detected down range, the system may, at 312, such as via the tracking computer 106, determine object flight characteristics based on the data from one or both of the LIDAR device and/or the vision device. In some embodiments, object flight characteristics may include the object's flight speed, direction, range, spin, trajectory, etc. At 314, the system, such as via tracking computer 106, may determine object launch conditions based on the object flight characteristics. In some embodiments, object launch conditions may be launch angle, speed, spin, etc. In some embodiments, the object launch conditions may also include information regarding the launch object, such as a golf club or golf club face, at the time of launch. For example, in some embodiments, the system may determine the club head speed, club face angle, angle of attack, etc.

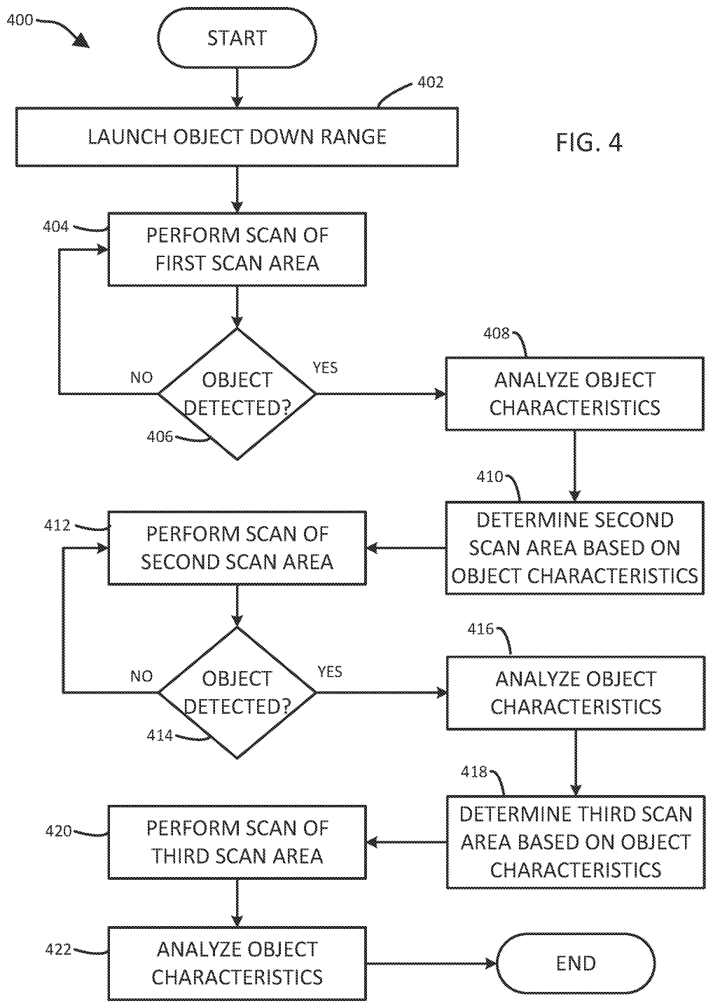

FIG. 4 is a flow chart of an embodiment 400 of implementing a dynamic field of view method, such as shown and described above with reference to FIGS. 2A-C. At 402, an object, such as a golf ball, may be launched down range, such as by being struck with a golf club. At 404, one or more LIDAR devices, such as LIDAR devices 104, may perform a scan of a first scan area to determine whether the object has been detected in the first scan area. If, at 406, the object is not detected, the LIDAR devices may continue scanning the first scan area. If the object is detected at 406, the system may, at 408, analyze object characteristics of the object, such as location, speed, trajectory, shape, etc. At 410, the system may determine a second scan area based on the object characteristics. In some embodiments, the second scan area may be a smaller scan area than the first scan area, and may enable the LIDAR device to improve the scan rate and/or the resolution of the scan. At 412, the LIDAR device may perform a scan of the second scan area. At 414, if no object is detected in the second scan area, the LIDAR device may continue scanning the second scan area. Alternatively, in some embodiments, if no object may be detected in the second scan area at 414, the LIDAR device may return to scanning the first scan area for the object. If the object is detected in the second scan area at 414, the system may analyze object characteristics of the object at 416, and determine a third scan area based on the object characteristics at 418. In some embodiments, the third scan area may have a smaller area than the second and/or the first scan area. At 420, the LIDAR device may perform a scan of the third scan area and, at 422, may analyze object characteristics of the object detected in the third scan area. Those skilled in the art will appreciate that the method 400 may continue iterating to determine additional scan areas that may provide for more improved resolution and scan rate of the object in flight.

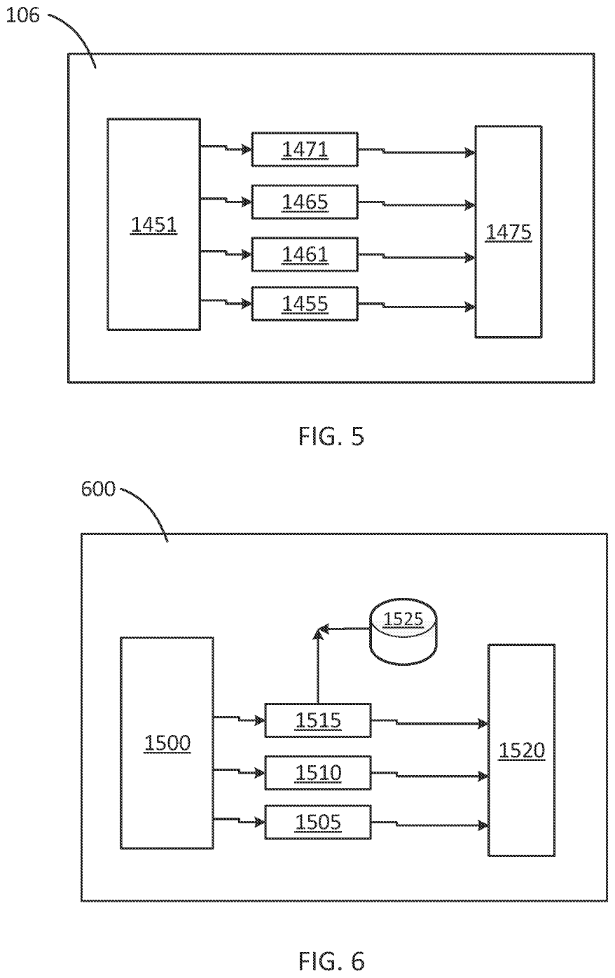

FIG. 5 is a simplified illustration of some physical elements that may make up an embodiment of a computing device, such as the tracking computer 106, and FIG. 6 is a simplified illustration of the physical elements that make up an embodiment of a server type computing device 600, such as may be used for remote cloud computing related to the 3D object tracking system 100. Referring to FIG. 5, a sample computing device is illustrated that is physically configured to be part of the object tracking systems and methods. The computing device 106 may have a processor 1451 that is physically configured according to computer executable instructions. In some embodiments, the processor may be specially designed or configured to optimize communication between a server relating to the system described herein. The computing device 106 may have a portable power supply 1455 such as a battery, which may be rechargeable. It may also have a sound and video module 1461 which assists in displaying video and sound and may turn off when not in use to conserve power and battery life. The computing device 106 may also have volatile memory 1465 and non-volatile memory 1471. The computing device 106 may have GPS capabilities that may be a separate circuit or may be part of the processor 1451. There also may be an input/output bus 1475 that shuttles data to and from the various user input/output devices such as a microphone, a camera, a display, or other input/output devices. The computing device 106 also may control communicating with networks either through wireless or wired devices. Of course, this is just one embodiment of a computing device 106 and the number and types of computing devices 106 is limited only by the imagination.

The physical elements that make up an embodiment of a server, remote cloud server 600, are further illustrated in FIG. 6. In some embodiments, the server may be specially configured to run the system and methods for tracking 3D objects as disclosed herein. At a high level, the server may include a digital storage such as a magnetic disk, an optical disk, flash storage, non-volatile storage, etc. Structured data may be stored in the digital storage a database. More specifically, the server 600 may have a processor 1500 that is physically configured according to computer executable instructions. In some embodiments, the processor 1500 can be specially designed or configured to optimize communication between a computing device, such as computing device 106, and A/V equipment or remote cloud server 600 as described herein. The server may also have a sound and video module 1505 which assists in displaying video and sound and may turn off when not in use to conserve power and battery life. The server 600 may also have volatile memory 1510 and non-volatile memory 1515.

A database 1525 for digitally storing structured data may be stored in the memory 1510 or 1515 or may be separate. The database 1525 may also be part of a cloud of servers and may be stored in a distributed manner across a plurality of servers. There also may be an input/output bus 1520 that shuttles data to and from the various user input devices such as a microphone, a camera, a display monitor or screen, etc. The input/output bus 1520 also may control communicating with networks either through wireless or wired devices. In some embodiments, a launch tracker controller for running a launch tracker API may be located on the computing device 106. However, in other embodiments, the launch tracker controller may be located on server 600, or both the computing device 106 and the server 600. Of course, this is just one embodiment of the server 600 and additional types of servers are contemplated herein.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A system for determining kinematics of at least one object, the system comprising;
a tracking computer including one or more processors and a memory;
a camera system in electronic communication with the tracking computer and configured to capture images of the at least one object;
a light detection and ranging (LIDAR) system in electronic communication with the tracking computer and configured to detect the at least one object;
wherein the memory contains processor-executable instructions that, when executed by the one or more processors, cause the tracking computer to:
receive image data from the camera system and receive LIDAR data from the LIDAR system, and
analyze the image data and the LIDAR data to determine flight characteristics of the at least one object.

2. The system of claim 1, wherein the camera system is configured to capture a sequential series of two or more images.

3. The system of claim 1, wherein the camera system is configured to capture a plurality of images at a frame rate of greater than 500 frames per second.

4. The system of claim 1, wherein the camera system is configured to capture a plurality of images at a frame rate of greater than 1,000 frames per second.

5. The system of claim 1, wherein the LIDAR system has a scan frequency of greater than 150 kHz.

6. The system of claim 5, wherein the LIDAR system has a pulse wavelength between 1500 nm to 2000 nm.

7. The system of claim 1, wherein the image and light detection data are wirelessly transmitted to the tracking computer.

8. The system of claim 1, wherein the flight characteristics of the at least one object include three dimensional displacement and velocity of the at least one object.

9. The system of claim 1 further comprising a strobe lighting element and a triggering device, wherein the strobe lighting element is tied to the triggering device so as to synchronize with the LIDAR system.

10. A system for determining kinematics of at least one object, the system comprising;
a tracking computer including one or more processors and a memory;
a light detection and ranging (LIDAR) system in electronic communication with the tracking computer and configured to detect the at least one object;
wherein the memory contains processor-executable instructions that, when executed by the one or more processors, cause the tracking computer to:
receive LIDAR data from the LIDAR system, and
analyze the LIDAR data to determine flight characteristics of the at least one object.

11. The system of claim 10 further comprising a triggering device in electronic communication with the tracking computer, the triggering device configured to transmit a launch signal to the tracking computer when the at least one object is launched from a launch point.

12. The system of claim 10, wherein the LIDAR system has a scan frequency of greater than 150 kHz.

13. The system of claim 10, wherein the LIDAR system has a pulse wavelength between 1500 nm to 2000 nm.

14. The system of claim 10, wherein the LIDAR system includes multiple LIDAR devices configured to detect the at least one object.

15. The system of claim 14, wherein the LIDAR system includes a first LIDAR device and a second LIDAR device, the first and second LIDAR devices each configured to detect the at least one object,
wherein the first LIDAR device is configured to scan for the at least one object in a first field of view and the second LIDAR device is configured to scan for the at least one object in a second field of view different than the first field of view.

16. The system of claim 15, wherein the first LIDAR device emits and receives at a different frequency than the second LIDAR device.

17. The system of claim 10, wherein the LIDAR system includes one or more LIDAR devices configured to emit multiple lasers simultaneously.

18. A method of tracking a three-dimensional (3D) object, the method comprising:
scanning for the 3D object using one or more LIDAR devices in one or more fields of view;
detecting the 3D object using the one or more LIDAR devices;
generating LIDAR data with the one or more LIDAR devices based on the detecting of the 3D object;
transmitting the LIDAR data from the one or more LIDAR devices to a tracking computer; and
analyzing the LIDAR data to determine flight characteristics of the 3D object based on the LIDAR data.

19. The method of claim 18, wherein the flight characteristics of the 3D object include at least one of launch angle, speed, trajectory, and spin.

20. The method of claim 18 further comprising:
capturing image data of the 3D object; and
analyzing the image data to determine flight characteristics of the 3D object.
